(19) United States
(12) Patent Application Publication
(10) Pub. No.: US 2023/0312406 A1
(43) Pub. Date: Oct. 5, 2023

(54) QUARTZ GLASS SUBSTRATE WITH IMPROVED ADHESION OF THERMAL SPRAY COATING, ITS MANUFACTURING METHOD, AND METHOD FOR MANUFACTURING QUARTZ GLASS PARTS COVERED WITH THERMAL SPRAY COATING

(71) Applicant: Techno Quartz Inc., Tokyo (JP)

(72) Inventors: Masahide KATO, Yamagata-shi (JP); Yasuhiro UMETSU, Yamagata-shi (JP); Yo MATSUURA, Yamagata-shi (JP)

(21) Appl. No.: 18/185,527

(22) Filed: Mar. 17, 2023

(30) Foreign Application Priority Data
Apr. 1, 2022 (JP) 2022-062181

(51) Int. Cl. C03C 17/10; C03C 19/00; C03C 23/00; C03C 17/22

(52) U.S. Cl. CPC C03C 17/10; C03C 19/00; C03C 23/007; C03C 17/22; C03C 2217/25; C03C 2218/112; C03C 2218/31; C03C 2201/02

(57) ABSTRACT

A method for manufacturing a quartz glass substrate with a coating formed includes: surface roughening for a base surface of the quartz glass substrate, on which the sprayed coating is formed; and a heating treatment of heating the substrate after the surface roughening. The base surface is 0.9 μm or more and 5.0 μm or less in arithmetic mean roughness (Ra) in the surface roughening. The heating treatment is performed at a temperature that is equal to or higher than a strain point (temperature at which the viscosity reaches 10^{13.5} Pa·sec) of the quartz glass.

### BACKGROUND OF THE INVENTION

### 1. Technical Field

The present invention relates to a quartz glass substrate with improved adhesion to a thermal spray coating, a manufacturing method therefor, and a method for manufacturing a quartz glass part covered with a thermal spray coating, and more particularly, relates to a surface treatment technique for a base surface on which a thermal spray coating is to be provided.

### 2. Description of the Related Art

Conventionally, quartz glass materials have been widely used as chamber constituent members of apparatuses for manufacturing devices such as semiconductors or flat panel displays. For such chamber constituting members made of quartz glass (hereinafter, referred to as “quartz glass substrates”), depending on the applications, the surfaces of the quartz glass substrates are coated with thermal spray coatings of for improving various performances.

In addition, the adhesion of the sprayed coating to the substrate is known to be mainly caused by mechanical bonding due to the anchor effect, and as with metal substrates, also in the formation of the sprayed coating on the quartz glass substrate, the base surface is indispensably roughened by a blasting treatment or the like.

For example, JP 2002-249864 A proposes a halogen-gas plasma-resistant member exposed to halogen-gas plasma, including a main body for the member and a corrosion-resistant film formed on at least a surface of the main body, where a material for the corrosion-resistant film is sprayed to form a sprayed film to be 15 MPa or more in peeling strength with respect to the main body. In addition, this document proposes that the sprayed film (and the member main body, if necessary) is subjected to a heating treatment after the formation of the sprayed film to make the sprayed film further sintered, and cause pores in the sprayed film to disappear or reduce, and that the heating treatment temperature for the sprayed film is 1400° C. or higher, thereby significantly increasing the peeling strength of the corrosion-resistant film.

In addition, for example, JP 2005-126768 A proposes, as a method for forming a protective film capable of preventing microcracks from being generated at the surface of a ceramic material and preventing a plasma-resistant protective film from being peeled in the formation of a protective film made of a plasma-resistant material layer by plasma spraying on the surface of a brittle material such as a ceramic material, a method for forming a sprayed film, including: a roughening step of chemically roughening the surface of a brittle material; and a spraying step of spraying a protective film on the surface of the brittle material, where the surface of the roughened brittle material is adjusted to 1 to 10 in arithmetic mean roughness (Ra) in the roughening step. Further, this document also proposes that the brittle material is a ceramic sintered body containing crystals of 2 to 70 μm in particle size, the ceramic sintered body is subjected to surface roughening by a treatment with an acidic etching solution, thereby allowing for suppressing the generation of microcracks, and forming a roughened surface structure with deep groove, and thus, the adhesion between the sprayed film formed on the surface and the brittle substrate is improved, thereby allowing the formation of the sprayed film, which is less likely to peel off and generate dust.

In addition, JP 2003-212598 A proposes a quartz glass part where a ceramic sprayed film of 5 to 20 μm in surface roughness Ra with a relative density of 70 to 97% is formed on a quartz glass substrate, as an excellent quartz glass part that has high adhesion to a filmy substance deposited or high plasma resistance and can be continuously used for a long time. Further, this document proposes a quartz glass part where a ceramic sprayed film of 1 to 20 μm in surface roughness Ra is formed on the surface of a quartz glass substrate with 10 to 200 grooves/mm each of 5 to 50 μm in width.

### SUMMARY OF THE INVENTION

As described above, it is known that the surface of a quartz glass substrate is covered with a coating, and furthermore, JP 2002-249864 A proposes that the sprayed film is subjected to the heating treatment at 1400° C. or higher, thereby increasing the peeling strength of the corrosion-resistant film, and JP 2005-126768 A proposes that the ceramic sintered body is chemically subjected to surface roughening by the treatment with the acidic etching solution to suppress the generation of microcracks and form a roughened surface structure with deep groove, thereby improving the adhesion between the coating and the brittle substrate. Further, according to JP 2003-212598 A, the sprayed film is formed on the surface of the quartz glass substrate with 10 to 200 grooves/mm each of 5 to 50 μm in width.

These prior art documents, however, fail to study an increase in peeling strength in the case of increasing the thickness of the coating.

More specifically, in recent years, there have been increasing needs for 3R (Reduce, Reuse, Recycle) for consumable members for the purpose of reducing the environmental load and reducing the cost in device manufacture, and for example, increasing needs for increasing the lives of consumable members by the formation of coatings as protective films, and further, for recycling consumed or deteriorated coatings. In relation to these needs, the coatings tend to be thickened for reasons such as further improving the durability of the protective films or machining the coatings themselves to form functional patterns on the protective films themselves. Quartz glass is, however, a material that is extremely small in coefficient of thermal expansion, and in the case of forming a coating by a thermal process such as thermal spraying, or in the case of a use environment for the coating in a thermal process, simply increasing the roughness of the base surface of a quartz glass substrate for improving the adhesion of the coating has the problem of failing to alleviate a difference in thermal expansion or film stress, thereby causing various defects such as substrate fracture, film peeling, or insufficient adhesion. Furthermore, the case where a quartz glass substrate is mechanically roughened by a blasting treatment or the like also has a problem peculiar to brittle materials in that the mechanical strength of the substrate is significantly reduced due to the influence of minute cracks (hereinafter, referred to as “microcracks”) formed in the base surface layer. Thus, for improving the adhesion of a coating to the quartz glass substrate, there are two conflicting ideas: the idea that it is better to increase the roughness of the substrate in expectation of an anchor effect; and the idea that it is better not to excessively roughen the base surface so as to keep the mechanical strength of the base surface from being decreased, but which one should be prioritized has not been sufficiently studied.

Accordingly, an object of the present invention to provide a quartz glass substrate, which eliminates the risk of film peeling or substrate fracture associated with the increased film thickness of a coating, a method for manufacturing the quartz glass substrate, and a method for manufacturing a quartz glass part with the quartz glass substrate used, another object of the present invention is to provide a quartz glass substrate capable of further improving the adhesion of a coating that can withstand severe use environments, a method for manufacturing the quartz glass substrate, and a method for manufacturing a quartz glass part with the quartz glass substrate used, and still another object of the present invention is to provide a quartz glass substrate including a base with high coating adhesion even in the formation of a coating thickened, a method for manufacturing the quartz glass substrate, and a method for manufacturing a quartz glass part with the quartz glass substrate used.

In order to solve at least any one of the problems mentioned above, the present invention provides a quartz glass substrate characterized by a base surface thereof, on which a coating is formed, a method for manufacturing the quartz glass substrate, and a method for manufacturing a quartz glass part with the use of the quartz glass substrate.

More specifically, the present invention provides method for manufacturing a quartz glass substrate with a sprayed coating formed, including: surface roughening for a base surface of the glass substrate, on which the coating is formed; and a heating treatment of heating the substrate after the surface roughening, where the base surface is 0.9 μm or more and 5.0 μm or less in arithmetic mean roughness (Ra) in the surface roughening, and the heating treatment is performed at a temperature that is equal to or higher than the strain point (that is, a temperature at which the viscosity reaches 10^{13.5} Pa·sec) of the quartz glass. Also after the heating treatment, the arithmetic mean roughness (Ra) of the base surface is 0.9 μm or more and 5.0 μm or less.

In the method for manufacturing the quartz glass substrate, the surface roughening can be performed by abrasive machining such as a blasting treatment, and the heating treatment can be performed by heating retention in a temperature range that is equal to or higher than the strain point of the quartz glass and equal to or lower than the annealing point (that is, a temperature at which the viscosity reaches 10^{12.0} Pa·sec) of the quartz glass. The temperature of the heating treatment is equal to or lower than the annealing point or, thereby allowing the quartz glass substrate to kept from being thermally deformed.

In addition, the present invention provides, in order to solve at least any one of the problems, a quartz glass substrate subjected to base control for enhancing the adhesion of a coating. More specifically, the present invention provides a quartz glass substrate on which a coating is to be formed, where the base surface of the quartz glass substrate on which the coating is to be formed is 0.9 μm or more and 5 μm or less in arithmetic mean roughness (Ra), and the microcrack at the base surface is 18 μm or less, desirably 10 μm or less in depth (depth in the thickness direction and the planar direction). In addition, the quartz glass substrate provides a quartz glass substrate on which a coating is formed, where the base surface on which the coating is formed is subjected to the surface roughening and base control by the heating treatment, and the base surface is 0.9 μm or more and 5.0 μm or less in arithmetic mean roughness (Ra).

Further, the present invention provides, in order to solve at least any one of the problems, a quartz glass part formed with the use of the quartz glass substrate. More specifically, provided is a quartz glass part with a coating of a metal or a ceramic formed on a quartz glass substrate, where the quartz glass substrate is subjected to the surface roughening and base control by the heating treatment, the base surface is 0.9 μm or more and 5.0 μm or less in arithmetic mean roughness (Ra), and the coating of the metal or ceramic is formed by thermal spraying on the base surface.

Further, the present invention provides a method for manufacturing a quartz glass part with a coating of a metal or a ceramic formed on a quartz glass substrate, where the quartz glass substrate is manufactured by the manufacturing method according to the present invention, and the method includes a coating forming treatment of forming a sprayed coating of a metal or a ceramic on the base surface subjected to the surface roughening, after the heating treatment.

The quartz glass substrate for coating formation according to the present invention is, because the base surface of the quartz glass substrate on which a coating is to be formed is 0.9 μm or more and 5 μm or less in arithmetic mean roughness (Ra), and the microcrack at the base surface is 18 μm or less in depth, capable of enhancing the adhesion of a coating formed, and eliminating the risk of film peeling or substrate fracture associated with the increased film thickness of the coating to withstand severe use environments.

In addition, when the quartz glass substrate is subjected to the surface roughening and the base control by the heating treatment to provide the base surface of 0.9 μm or more and 5.0 μm or less in arithmetic mean roughness (Ra), microcracks formed at the base surface layer subjected to the surface roughening are appropriately joined by the heating treatment, and the mechanical strength of the base is increased. Accordingly, the base surface of the quartz glass substrate can be provided with the enhanced adhesion of the coating, and the risk of film peeling or substrate fracture associated with the increased film thickness of the coating can be eliminated to provide a quartz glass substrate that can withstand severe use environments.

In addition, the method for manufacturing a quartz glass substrate according to the present invention includes the heating treatment of heating the substrate after the surface roughening for the base surface of the quartz glass substrate, on which the coating is formed, thus allowing the base surface of the quartz glass substrate, on which the coating is formed, to be improved to enhance the adhesion of the coating. Accordingly, the risk of film peeling or substrate fracture associated with the increased film thickness of the coating can be eliminated to manufacture a quartz glass substrate that can withstand severe use environments.

In particular, when the heating treatment is performed at a temperature that is equal to or higher than the strain point of the quartz glass after the surface roughening is performed by the blasting treatment, the adhesion of the coating can be significantly enhanced as compared with the case where the heating treatment is not performed.

As will be described later, the fact that microcracks formed at the base surface layer by surface roughening are appropriately joined by heating treatment is remarkable in the case of heating retention at a temperature that is equal to or higher than the strain point of quartz glass. Furthermore, it has been confirmed that a similar effect of microcrack joining is achieved even when the temperature of the heating treatment is made higher than the strain point by 100° C. or more, but in general, when quartz glass is heated and held at a temperature that is higher than the annealing point, the base material is known to be severely deformed, thereby causing a problem that a quartz glass substrate precisely shaped is thermally deformed. In fact, an annealing treatment for heating and holding the substrate is performed also after flame welding of quartz glass, but the upper limit of the temperature for the annealing treatment is made equal to or lower than the annealing point for suppressing the thermal deformation. Thus, the heating treatment performed after the surface roughening for the quartz glass substrate according to the present invention is desirably held in an electric furnace at a temperature that is equal to or higher than the strain point of the quartz glass and equal to or lower than the annealing point thereof.

### BRIEF DESCRIPTION OF THE DRAWINGS

FIG. 1 is a workflow diagram illustrating a process of manufacturing a quartz glass substrate and a quartz glass part with the glass substrate used, according to the present embodiment;

FIG. 2 is a perspective view illustrating microcracks generated at the time of a blasting treatment;

FIG. 3 is a graph showing results of Experimental Example 1;

FIG. 4A shows a graph showing results of Experimental Example 2;

FIG. 4B shows a graph showing results of Experimental Example 2;

FIG. 4C shows a graph showing results of Experimental Example 2;

FIG. 4D shows a graph showing results of Experimental Example 2;

FIG. 5A shows a correlation diagram between surface roughness and adhesion strength, showing results of Experimental Example 4;

FIG. 5B shows a correlation diagram between surface roughness and adhesion strength, showing results of Experimental Example 4;

FIG. 6A shows a graph showing results of Experimental Example 4;

FIG. 6B shows a graph showing results of Experimental Example 4;

FIG. 6C shows a graph showing results of Experimental Example 4;

FIG. 6D shows a graph showing results of Experimental Example 4;

FIG. 7 shows enlarged photographs showing results of Experimental Example 5;

FIG. 8 shows enlarged photographs showing results of Experimental Example 5;

FIG. 9 shows enlarged photographs showing results of Experimental Example 6;

FIG. 10 shows enlarged plan photographs and enlarged cross-section photograph showing results of Experimental Example 6;

FIG. 11 shows enlarged plan photographs and enlarged cross-section photograph showing results of Experimental Example 6;

FIG. 12A shows a correlation diagram between surface roughness and adhesion strength, showing results of Experimental Example 7;

FIG. 12B shows a correlation diagram between surface roughness and adhesion strength, showing results of Experimental Example 7; and

FIG. 13 is a graph showing results of Experimental Example 8.

### DETAILED DESCRIPTION

Hereinafter, a quartz glass substrate 10, a manufacturing method therefor, and a quartz glass part 60 formed with the use of the substrate according to the present embodiment will be specifically described with reference to the drawings. In particular, the present embodiment presents an embodiment in which with a quartz glass substrate 10 used, a base surface thereof with a metal or ceramic coating 51 to be formed is subjected to surface roughening with abrasive grits projected from a blasting device 20. The substrate with the coting 51 to be formed may be, however, another material, and the surface roughening may be abrasive machining such as lapping or grinding with a diamond tool, besides the blasting treatment. Furthermore, according to the following embodiment, the protective coating 51 is formed by thermal spraying, but the protective coating may be formed by other methods.

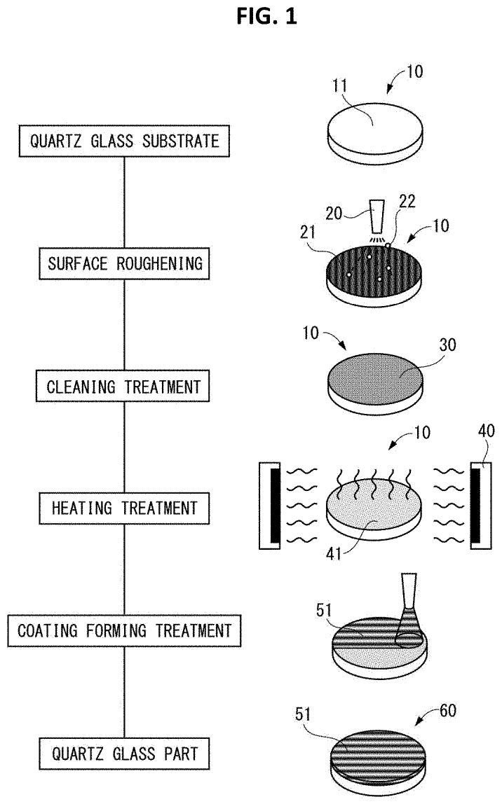

FIG. 1 is a work flow diagram illustrating a process of manufacturing a quartz glass substrate 10 and a quartz glass part 60 with the glass substrate used, according to the present embodiment; As illustrated in this figure, the quartz glass substrate 10 with the coating 51 to be formed is subjected to base control for roughening a region (hereinafter, referred to as a “target region 11”) where the coating 51 is to be formed.

In particular, in the case of surface roughening by blasting treatment, the abrasive grit used for the blasting treatment can be appropriately selected depending on the workpiece to be subjected to grinding, and for example, an alumina abrasive, a silicon carbide abrasive, or the like can be used. When the object to be subjected to grinding is the quartz glass substrate 10 as in the present embodiment, a black silicon carbide abrasive (abbreviation: C) or a green silicon carbide abrasive (abbreviation: GC) can be used. The surface of the target region will be roughened by such a surface roughening, and the surface roughness can be appropriately adjusted depending on the blasting conditions (the particle size of the abrasive grit, the discharge air pressure, and the like).

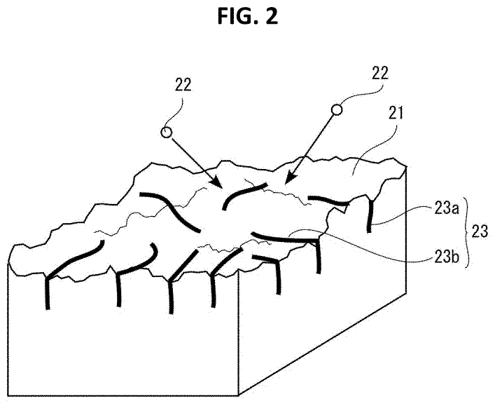

In particular, in the blasting treatment, the abrasive grit is projected to the base surface of the target region 11 of the target quartz glass substrate 10 to perform surface roughening and form a rough surface 21. In this case, as illustrated in FIG. 2, microcracks 23 are generated at the base surface layer due to the impact caused by the collision of the abrasive grit 22. The microcracks 23 include microcracks 23a generated in the thickness direction of the quartz glass substrate 10, and also microcracks 23b generated in a planar direction (that is, radially) with respect to the base surface of the quartz glass substrate. In addition, the depths and lengths of the microcracks 23 (that is, the reference numerals 23a and 23b) generated in the thickness direction and the planar direction also depend on the blasting conditions, and may reach several hundred μm when the surface is excessively roughened.

Thus, conventionally, for eliminating the fragility of the rough surface with the microcracks 23, a surface treatment (that is, etching treatment) performed through the use of the chemical corrosive action by a hydrofluoric acid has been known from a long time ago. The quartz glass substrate 10 subjected to the blasting treatment is immersed in a hydrofluoric acid, thereby causing the wetted surface to be progressively etched, and increasing the curvature radius of the crack tip, together with the opening of the initial microcrack 23. Thus, also when external stress is applied to the substrate, the stress concentration generated at the crack tip will be alleviated, and the practical strength of the quartz glass substrate 10 will be improved.

In contrast, in the method for manufacturing the quartz glass substrate 10 according to the present embodiment, a heating treatment for heating the substrate is performed after the surface roughening. The heating temperature in such a heating treatment can be appropriately adjusted depending on the material of the quartz glass, and the heating treatment is performed by heating retention at a temperature that is equal to or higher than the strain point of the quartz glass. In addition, this heating treatment is, for preventing the quartz glass substrate from being thermally deformed, desirably performed by heating retention at a temperature that is equal to or lower than a annealing point. For example, when the material of the quartz glass substrate 10 is anhydrous quartz glass produced by an electrically-fused method, the strain point is approximately 1120° C., and the annealing point is approximately 1220° C. In addition, in the case of the hydrous quartz glass produced by an oxy-hydrogen flame fusion method, the strain point is approximately 1070° C., and the annealing point is approximately 1160° C. As described above, the temperature of the heating treatment in the present embodiment can be appropriately adjusted in consideration of the thermal characteristics depending on the material of the quartz glass.

In addition, the heating treatment can be performed by an existing heating method, and when the target workpiece is the quartz glass substrate 10, the heating treatment can be performed by holding the workpiece in the furnace of an electric furnace equipped with a common resistance heating-type heater 40. As for the heating retention time at the heating temperature, unlike the annealing treatment described above, a uniform temperature is not necessary from the workpiece surface to the inside of the workpiece, it is thus not necessary to fine-adjust the heating retention time depending on the workpiece size, and the retention for approximately 30 minutes or longer, in particular, approximately 60 minutes is desirable after the inside of the electric furnace for performing the heating treatment reaches the heating temperature.

Such a heating treatment is performed, thereby appropriately joining the microcracks generated by the blasting treatment, and as a result, the fragility of the target region is eliminated to allow a heat-treated surface 41 that also improves the adhesion of the coating 51.

After the surface roughening is performed, it is necessary to perform a cleaning treatment before the heating treatment. More specifically, when the heating treatment at 1000° C. or higher is performed while contaminants that cause crystallization of the quartz glass material remain on the substrate surface, cracking (that is, devitrification) associated with the crystallization will make the use impossible as the substrate according to the present embodiment. Thus, in this cleaning treatment, after chemical cleaning with a chemical solution or physical cleaning with ultrasonic waves or the like, sufficient rinsing with deionized water is performed to obtain a clean surface 30 from which various contaminants adhering in the surface roughening step have been removed, and then, the heating treatment in the next step is performed. Further, light etching (that is, a cleaning treatment) with a dilute hydrofluoric acid (hereinafter, referred to as a “DHF”) may be performed as a cleaning treatment before and after the heating treatment. More specifically, for obtaining the clean surface 30 after the surface roughening treatment, a cleaning treatment with a DHF may be performed before the heating treatment, and in a case where a contaminant adheres in handling the quartz glass substrate 10 after the heating treatment, a cleaning treatment with a DHF may be performed again. As described later, however, it has been found that when an etching (hard etching) treatment is performed by excessive immersion in a hydrofluoric acid after mechanical surface roughening, followed by the formation of a sprayed coating on the base surface etched more than necessary, there is a risk of substrate fracture during the application of coating or in the application of external stress to the substrate subjected to thermal spraying. This is believed to be because, when a sprayed coating is formed on the base surface excessively etched, the spray material penetrates also into the groove of the microcrack opening enlarged by the etching, thus generating, in the substrate, high stress (that is, strain) due to a difference in thermal expansion between the coating and the quartz glass material, and increasing the risk of substrate fracture. For avoiding the risk of substrate fracture, it is preferable to use a non-hydrofluoric acid-based chemical solution (for example, a sulfuric acid, a nitric acid, a hydrochloric acid, or the like) that does not etch the quartz glass material in the case of performing the cleaning treatment after the surface roughening.

The quartz glass substrate 10 with the target region 11 processed as described above is subjected to a coating forming treatment for forming the coating 51, thereby allowing the quartz glass part 60 according to the present embodiment to be manufactured. The coating 51 can be provided to improve various functions and performances depending on the application of the quartz glass part 60. Thus, the coating 51 can be determined, based on the function and performance depending on the application of the quartz glass part 60 to be formed. The coating 51 may be formed to have a two-layer structure of: an undercoat layer formed to have a material, a thickness, and/or a surface roughness determined from the viewpoint of the adhesion to the base surface of the quartz glass substrate 10; and a topcoat layer formed to have a material, a thickness, and/or a surface roughness determined from the viewpoint of the function and performance depending on the application of the quartz glass part 60 to be formed. Furthermore, for other functions and purposes, the coating 51 can be also formed to have a laminated structure of three or more layers.

The coating 51 can be formed by spraying a metal or a ceramic to the quartz glass substrate 10, and can be formed by a chemical vapor deposition method (CVD), an atomic layer deposition method (ALD), a sputtering method, a vapor deposition method, a plating method, or a coating method. In comprehensive consideration of time and cost related to film formation, material characteristics required for applications of manufacturing devices such as semiconductors and liquid crystals, adhesion, and the like, however, the formation by a thermal spraying method is desirable. In particular, in the case of forming the coating 51 by a thermal spraying method, the spraying method may be oxygen fuel spraying (flame spraying, high velocity flame spraying, detonation flame spraying), electric spraying (arc spraying, plasma spraying, or wire explosion spraying), or cold spraying. In addition, the heating treatment is performed after the surface roughening, thereby allowing the adhesion to be improved regardless of the film thickness of the coating 51, and in particular, when the film thickness of the coating formed is 300 μm or more, the effect of improving the adhesion to the base surface of the substrate according to the present invention is remarkable, which is thus advantageous in the case of the quartz glass part 60 with the coating 51 of 300 μm or more in film thickness.

In the quartz glass part 60 formed as described above, the fragility of the base surface is eliminated by the heating treatment for the quartz glass substrate 10, the coating 51 thus reliably in close contact with the quartz glass substrate 10 can solve the problem of the coating 51 peeled. In addition, in the quartz glass part 60, the adhesion is improved between the quartz glass substrate 10 and the coating 51, and thus, even when the film thickness of the coating 51 is increased, the risk of film peeling or substrate fracture associated with the increase is eliminated to allow the quartz glass part 60 to withstand severe use environments.

### Example 1

Hereinafter, some experiments were performed for confirming the effects of the quartz glass substrate and quartz glass part according to the present embodiment. In particular, in the following experimental examples, anhydrous synthetic quartz glass (material name “012” manufactured by Momentive Technologies) was used as a quartz glass substrate, and a coating of ceramic spraying by plasma spraying was formed, and experiments were then performed.

### Experimental Example 1

In this experiment, on a quartz glass substrate with the arithmetic mean roughness subjected to base control to the order of (Ra) 4 μm by a blasting treatment (abrasive grit: C #80, discharge air pressure: 0.4 MPa), sprayed coatings of 300 μm to 400 μm in film thickness were formed by atmospheric plasma spraying (hereinafter, referred to as “APS”) with the use of an alumina (Al₂O₃) powder, a silicon (Si) powder, a yttria (Y₂O₃) powder, and an alumina (Al₂O₃) coarse powder (coarser powder for thermal spraying in particle size than the alumina powder) as spray materials. Then, the film thickness and surface roughness for each thermal spray coating, the surface roughness of the quartz glass substrate base, and the tensile adhesion strength of the sprayed coating were measured.

The tensile adhesion strength of the sprayed coating was measured with reference to JIS H 8402 “Tensile Adhesion Strength Test Method for Sprayed Coating”. More specifically, a test piece was prepared by forming a sprayed coating of the spray material on one roughened surface of the quartz glass substrate (outer diameter: 25 mm, thickness: 5 mm), and then, a head of a hexagonal bolt made of stainless steel (SUS 304) was butted and bonded to both end surfaces of the test piece with the sprayed coating formed. For the bonding, a two-component mixed epoxy adhesive (trade name “DP-460” manufactured by 3M Japan Limited) was used to confirm in advance that a product of quartz glass and SUS 304 bonded was about 50 MPa (corresponding to a typical material strength of quartz glass) in tensile adhesion strength. For the test piece thus prepared, the adhesion strength was measured with a precision universal tester (“AG-100kNX” manufactured by Shimadzu Corporation). The conditions for the test were a tensile rate of 1 mm/min and the number of test pieces N=3 in accordance with JIS H 8402. In addition, the porosity of each sprayed coating was also measured in advance. As a method for measuring the porosity, first, a magnified image (photographing magnification: 200 times) of a cross section of the sprayed coating was photographed, and then, the area of a pore portion in the cross-sectional image of the sprayed coating was measured and calculated with the use of image analysis software (“WinROOF” manufactured by MITANI CORPORATION). In this regard, the size of the porosity measurement region in the cross-sectional image of the coating was 500 μm×200 μm. For each sprayed coating, the porosity obtained by measuring 5 fields is shown in Table 1.

TABLE 1

| | | | | | Alumina |
|---|---|---|---|---|---|
| | | | | | Coarse |
| Spray Material | | Alumina | Silicon | Yttria | Powder |
| Porosity | Field of | 3.2 | 3.6 | 4.2 | 23.4 |
| [%] | View 1 | | | | |
| | Field of | 4.0 | 3.5 | 4.5 | 24.4 |
| | View 2 | | | | |
| | Field of | 3.4 | 3.7 | 4.1 | 23.2 |
| | View 3 | | | | |
| | Field of | 3.3 | 3.4 | 3.9 | 21.7 |
| | View 4 | | | | |
| | Field of | 3.1 | 3.6 | 4.4 | 20.3 |
| | View 5 | | | | |
| | Average | 3.4 | 3.5 | 4.2 | 22.6 |
| | Value | | | | |

In the subsequent experimental examples, the average value in Table 1 is listed as the porosity of each sprayed coating.

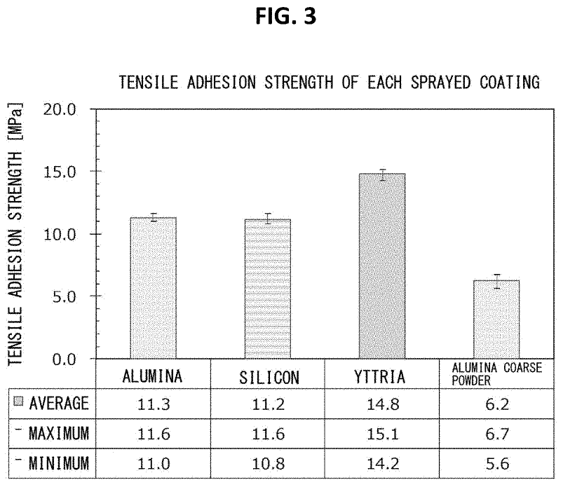

For each spray material, the results of measuring the film thickness and surface roughness of the sprayed coating, the surface roughness of the quartz glass substrate base, and the tensile adhesion strength, and the condition of the fracture surface are shown in Table 2 below. In addition, the tensile adhesion strength of the test piece (N=3) for each spray material is shown in FIG. 3.

TABLE 2

| | Sprayed Coating | | | Quartz Glass Base | | | | |
|---|---|---|---|---|---|---|---|---|
| | | Surface | | Surface | | | | |
| | Film | Roughness | | Roughness | | Adhesion | Site of | |
| Spray Material | Thickness | [μm] | | [μm] | | Strength | Fracture | Appearance of |
| (Average Porosity) | [μm] | Ra | Rmax | Ra | Rmax | [MPa] | Surface | Fracture Surface |
| Alumina (3.4%) | 360 | 3.2 | 31.4 | 4.5 | 45.2 | 11.3 | interface between coating-substrate | [symbol] |
| Silicon (3.5%) | 357 | 2.6 | 27.5 | 4.3 | 46.1 | 11.2 | interface between coating-substrate | [symbol] |
| Yttria (4.2%) | 350 | 4.8 | 47.9 | 4.2 | 45.1 | 14.8 | interface between coating substrate | [symbol] |
| Alumina Coarse Powder (22.6) | 350 | 5.1 | 48.3 | 4.5 | 44.5 | 6.2 | interface between coating-substrate | [symbol] |

In this experimental result, the fracture surfaces of the three test pieces for each spray material were all delaminated at the interface between the coating and the base, without any large individual difference in appearance among the fracture surfaces.

In addition, from the experimental results of the alumina and alumina coarse powder, it has been confirmed that the sprayed coatings of the same material that differ in porosity have a difference produced in adhesion. This is believed to mean that the dense coating achieves higher adhesion than the porous coating, because a difference in anchor effect was produced due to a difference in area of contact between the coating and the substrate base.

Furthermore, as for the yttria (Y₂O₃) and silicon (Si) with the same degree of porosity, the coefficient of thermal expansion is “Si<Y₂O₃”, and the coating adhesion strength is “Si<Y₂O₃” while the coefficient of thermal expansion of the Si is closer to that of the quartz glass of the substrate, and the Y₂O₃ that is larger in coefficient of thermal expansion than the Si was higher in adhesion strength.

### Experimental Example 2

In this experiment, a change in surface roughness of a quartz glass substrate subjected to surface roughening by a blasting treatment was investigated when the quartz glass substrate was subjected to post-treatments. Specifically, any one surface of a disk-shaped sample of 25 mm in outer diameter and 5 mm in thickness, made of anhydrous synthetic quartz glass (material name “012” manufactured by Momentive Technologies) was subjected to a blasting treatment (discharge air pressure: 0.4 MPa) with the use of four types of abrasive grits (C #80, GC #150, GC #280, and C #360) different in particle size to prepare four types of rough-surface samples with blasted surfaces adjusted to the range of 0.9 μm or more and 5.0 μm or less in arithmetic mean roughness (Ra). Then, as post-treatments for each rough-surface sample, three types of base control: non-treatment (that is, only blasting treatment); heating treatment; and etching treatment were performed to prepare 12 types of base-control samples in total.

In the heating treatment, the sample was held in an electric furnace under a heating condition of fixing at 1170° C. for 60 minutes. It is to be noted that the temperature of the heating treatment is substantially the same as the temperature of an annealing treatment performed after flame welding of anhydrous quartz glass, and the heating treatment performed in the present embodiment and the heating treatment for the purpose of annealing treatment after welding may be simultaneously performed. In addition, the etching treatment was performed by immersing each sample subjected to the blasting treatment in a hydrofluoric acid (concentration: 15 wt. %, liquid temperature: 23±1° C.) for 60 minutes.

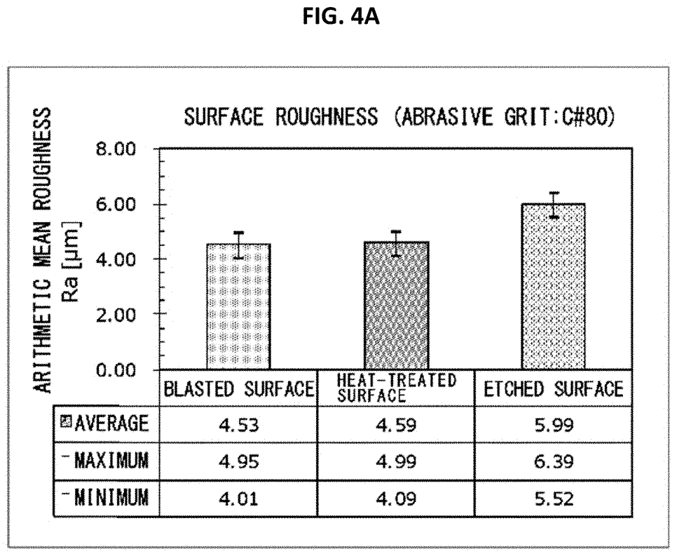

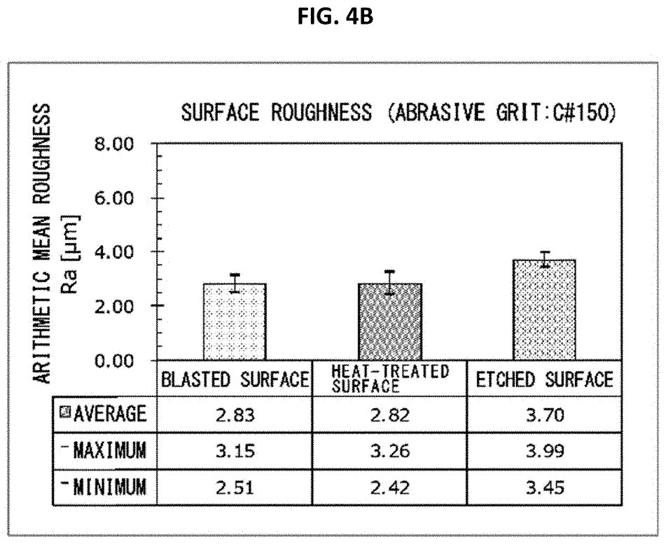

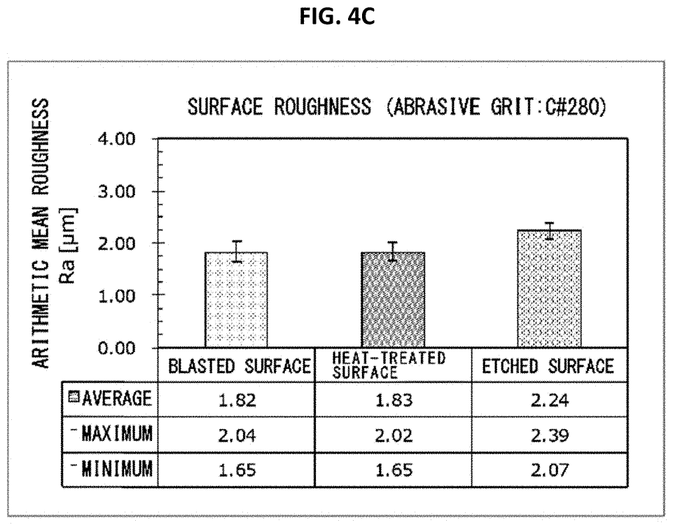

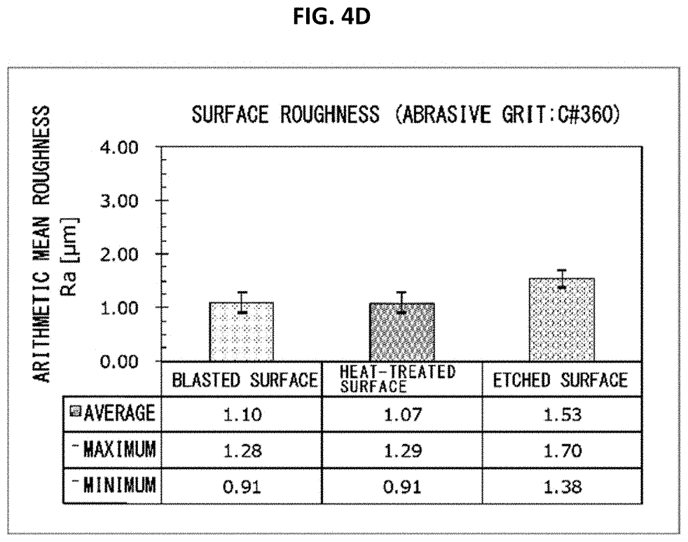

The number of samples was 10 for each of the 12 types of base-control samples in total, and the maximum, minimum, and average values were determined from the surface roughness data of each sample. The results are shown in FIG. 4.

From this experiment, it has been confirmed that with almost no change in surface roughness between the blasted surface and the heat-treated surface, the etching treatment performed after the blasting treatment tends to increase the surface roughness. The reason of the surface roughness increased after the etching treatment is believed to be because the opening width of the microcrack is enlarged when the microcrack formed by the blasting treatment is chemically eroded. In practice, when the etched surface was observed under magnification with a microscope to observe the crack opening width, the groove width was approximately 7 to 8 μm, which was a typical amount of dissolution in the case of immersion for 60 minutes in the 15 wt. % hydrofluoric acid (liquid temperature: 23±1° C.) used in this experiment.

### Experimental Example 3

In this experiment, with the use of the 12 types of base-control samples prepared according to Experimental Example 2, the sprayed coating of yttria (Y₂O₃) with the porosity of 5% or less, presented in Experimental Example 1, was formed on the base surface of each of the samples, and the sprayed coating was subjected to a tensile adhesion strength test in the same manner as in Experimental Example 1. Here, the sprayed coating of yttria (Y₂O₃) was formed by atmospheric plasma spraying (APS), and the film thickness was adjusted to 300 μm to 400 μm. In addition, the number of test pieces in the tensile adhesion strength test was N=3 for each base-control sample. The results are shown in Table 3 below.

TABLE 3

| | | | Coating | | Roughness | | | | |
|---|---|---|---|---|---|---|---|---|---|
| | | | Roughness | | of Quartz | | | | |
| | | Film | of Sprayed | | Glass Base | | Adhesion | Site of | |
| Base Control | | Thickness | [μm] | | [μm] | | Strength | Fracture | Appearance of |
| Abrasive grit | Post-Treatment | [μm] | Ra | Rmax | Ra | Rmax | [MPa] | Surface | Fracture Surface |
| C#80 | No | 350 | 4.82 | 47.90 | 4.16 | 45.09 | 14.8 | Interface between coating-base | [symbol] |
| | Heating Treatment | 350 | 5.11 | 52.76 | 4.60 | 44.00 | 18.9 | Interface between coating-base | [symbol] |
| | Etching Treatment | 351 | 5.13 | 45.67 | 6.05 | 50.41 | 7.6 | substrate fracture | [symbol] |
| GC#150 | No | 353 | 4.74 | 47.29 | 2.89 | 27.01 | 18.2 | Interface between coating-base | [symbol] |
| | Heating Treatment | 353 | 5.30 | 54.28 | 2.73 | 25.80 | 23.3 | Interface between coating-base | [symbol] |
| | Etching Treatment | 355 | 5.13 | 48.10 | 3.83 | 37.24 | 8.2 | substrate fracture | [symbol] |
| GC#280 | No | 359 | 5.02 | 50.10 | 1.71 | 16.15 | 20.3 | Interface between coating-base | [symbol] |
| | Heating Treatment | 357 | 4.94 | 44.82 | 1.81 | 17.24 | 27.6 | Interface between coating-base | [symbol] |
| | Etching Treatment | 353 | 4.55 | 46.84 | 2.21 | 20.85 | 18.7 | Interface between coating-base | [symbol] |
| C#360 | No | 356 | 4.99 | 45.65 | 1.09 | 10.25 | 23.2 | Interface between coating-base | [symbol] |
| | Heating Treatment | 352 | 5.19 | 47.01 | 1.05 | 9.73 | 24.6 | Interface between coating-base | [symbol] |
| | Etching Treatment | 348 | 4.79 | 48.06 | 1.71 | 15.61 | 21.6 | Interface between coating-base | [symbol] |

In this experiment, in the case of the base-control samples subjected to only the blasting treatment and the heating treatment after the blasting treatment, the fracture surfaces after the tensile test were all produced by interfacial peeling between the coating and the substrate base. In addition, in the case of the base-control samples subjected to the blasting treatment with the coarse particle sizes (C #80 and GC #150) and then to the etching treatment, the substrate itself was bulk-fractured at a value (10 MPa or less) significantly lower than the typical material strength (about 50 MPa) of quartz glass after the tensile test. This is believed to be because high tensile stress (that is, severe strain) was generated in the quartz glass substrate in the process of forming the sprayed coating, thereby causing the quartz glass base material to be bulk-fractured before the sprayed coating was peeled off by the load application in the tensile test. In contrast, the quartz glass substrate was not bulk-fractured in the tensile test in the case of the base-control samples subjected to the blasting treatment with the fine particle sizes (GC #280 and C #360) and then to the etching treatment.

### Experimental Example 4

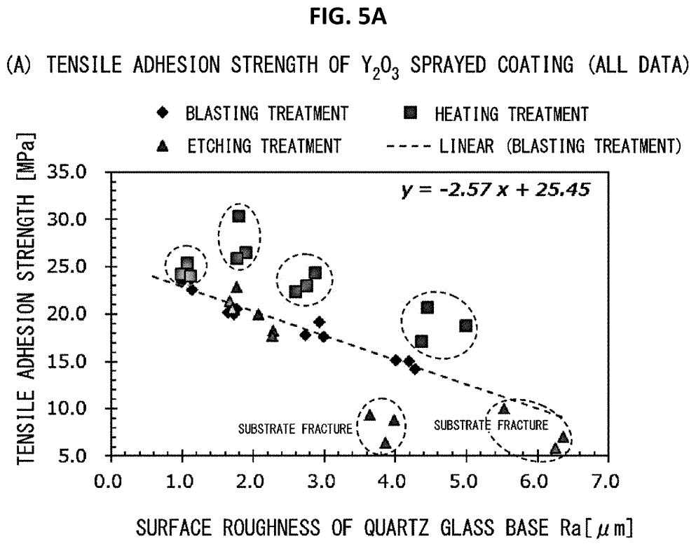

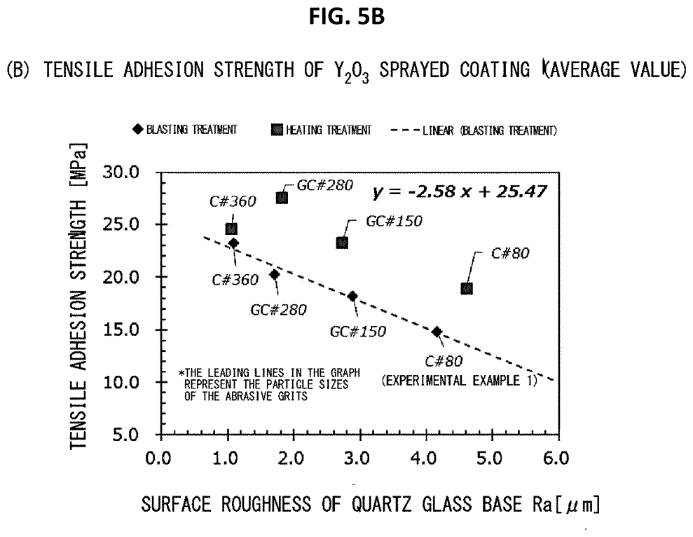

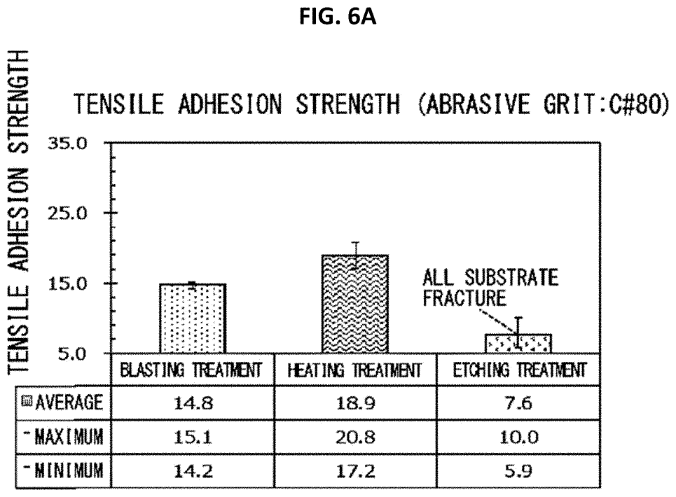

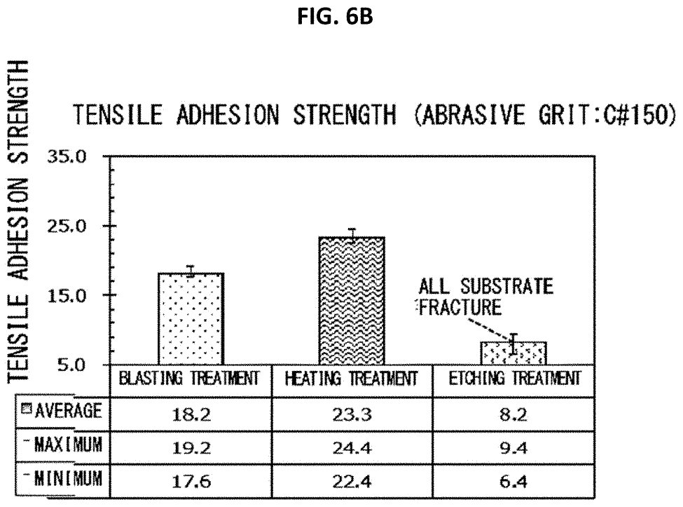

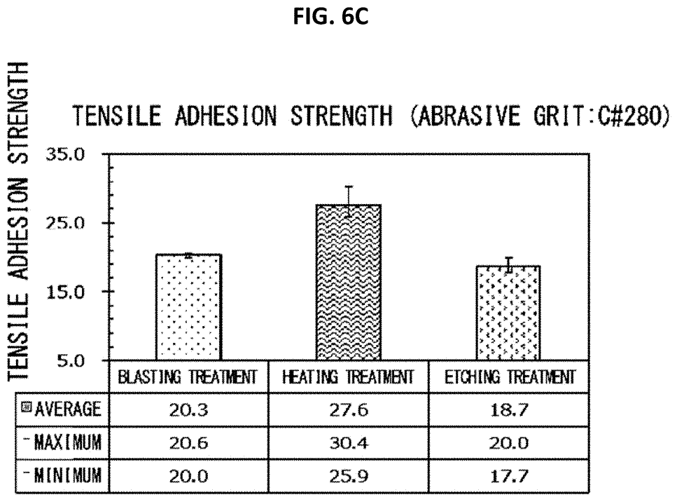

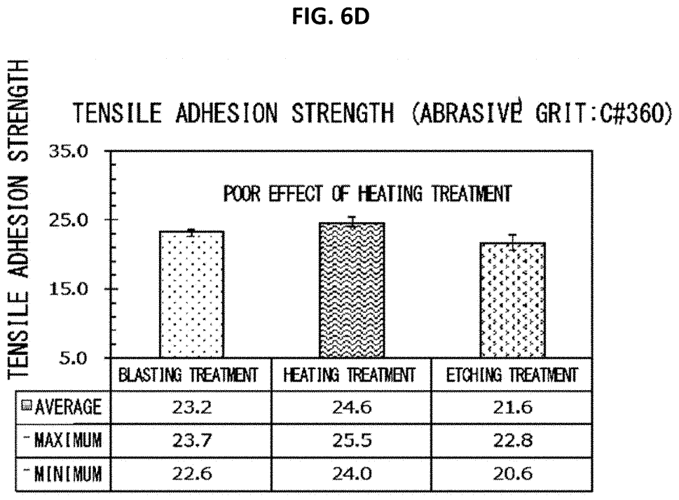

In this experiment, the correlation between the surface roughness of the base of the quartz glass substrate and the tensile adhesion strength of the sprayed coating of yttria (Y₂O₃) was considered from the experimental data of the tensile adhesion strength test performed in Experimental Example 3. The results are shown in FIGS. 5A and 5B. FIG. 5A plots individual data (all data) for each base-control sample and an interpolation line for the blasted samples, and FIG. 5B shows average values for the blasted samples and the heat-treated samples and an interpolation line of the average values for the blasted samples. In addition, FIG. 6 shows values of the tensile adhesion strength in the case of the samples subjected to the only the blasting treatment, the heating treatment after the blasting treatment, and the etching treatment after the blasting treatment, for each of the particle sizes of the abrasive grits.

From this experimental result, the adhesion strength of the sprayed coating to the sample subjected to the base control by the blasting treatment to be 0.9 μm to 5.0 μm in surface roughness Ra (that is, the sample subjected to only the blasting treatment) was higher when the surface roughness Ra of the base surface was reduced. This is a result that is completely opposite to the idea of expecting the anchor effect of the increased adhesion strength of the sprayed coating with the increased surface roughness of the base surface, which is widely known as a general theory.

In addition, the base-control samples subjected to the heating treatment after the blasting treatment have been found to have adhesion strength clearly improved as compared with the samples subjected to only the blasting treatment. Further, in order to obtain a coating adhesion strength of 20 MPa or more in consideration of variations, a good result was obtained when the arithmetic mean roughness Ra of the base surface subjected to the heating treatment according to the present embodiment after the blasting treatment was adjusted to 4.0 μm or less, in particular, 3.5 μm or less. Furthermore, the tensile strength with respect to the blast-treated base surface is expected to be about 25 MPa at a maximum from the roughness-strength interpolation lines shown in FIGS. 5A and 5B, and the base surface reliably in excess of the expected value is the heat-treated sample subjected to the base control to 1.60 μm to 2.05 μm in arithmetic mean roughness Ra, which is improved to about 1.9 times with respect to the coating adhesion strength in the blast-treated sample (without the heating treatment) subjected to the base control to the order of 4 μm in arithmetic mean roughness Ra.

Further, as can be seen from the graph of FIG. 6, the conventionally proposed base surface subjected to the etching treatment after the blasting treatment made almost no contribution to improving the adhesion of the sprayed coating, and rather had a risk of substrate fracture. In particular, in the case of the base-control sample subjected to the surface roughening with the use of the abrasive grits with the coarse particle sizes, such as C #80 or GC #150, the bulk fracture of the quartz glass substrate could be avoided by performing no etching treatment (that is, only the blasting treatment).

### Experimental Example 5

From the above-mentioned result of Experimental Example 4, the quartz glass substrate subjected to the etching treatment after the blasting treatment makes almost no contribution to improving the adhesion of the sprayed coating, and the etched surface is believed to have a risk of causing substrate fracture, and the cause thereof was thus examined in this experiment. In the blasting treatment, the base surface is known to undergo a brittle fracture due to the impact of collision of a high-hardness abrasive grit with quartz glass as a substrate, and have microcracks formed from the base surface in the thickness direction of the substrate, and actually, cracks of several tens μm to several hundreds μm in length are developed not only in the thickness direction but also in a planar direction (that is, radially with respect to the base surface). Further, when the quartz glass substrate subjected to the blasting treatment is etched by immersion in a hydrofluoric acid, cracks are eroded, openings are then formed, and a large number of elongated grooves appear in the planar direction. Further, at the time of forming the sprayed coating, the sprayed coating more remarkably penetrates as the crack opening openings are longer, and under the influence of a difference in thermal expansion between the quartz glass of the substrate and the sprayed coating, high tensile stress (that is, severe strain) is generated in the quartz glass substrate in a cooling process in the coating formation. In fact, the appearance of the fracture surface of the base-control sample subjected to the etching treatment, shown in Table 3, is remarkably similar to the fracture surface of a heat cracking phenomenon that is caused in flame welding of quartz glass, and in any case, the base material fracture is believed to be caused at a value that is significantly lower than the typical material strength (about 50 MPa) of quartz glass due to the influence of high tensile stress (that is, severe strain) in the quartz glass material.

Then, in this experiment, the quartz glass substrate was subjected to a blasting treatment with the use of abrasive grits of silicon carbide (C #80, GC #150, GC #280, and C #360), then, the substrate was immersed in a hydrofluoric acid (concentration: 15 wt. %, liquid temperature: 23±1° C.), and the presence or absence of the appearance of the crack opening grooves was observed under magnification with a microscope. The white parts appearing shiny in white in the enlarged photographs are considered as fragile parts in terms of strength, where incident light on the base surface is diffusely reflected due to the presence of surface-layer cracks.

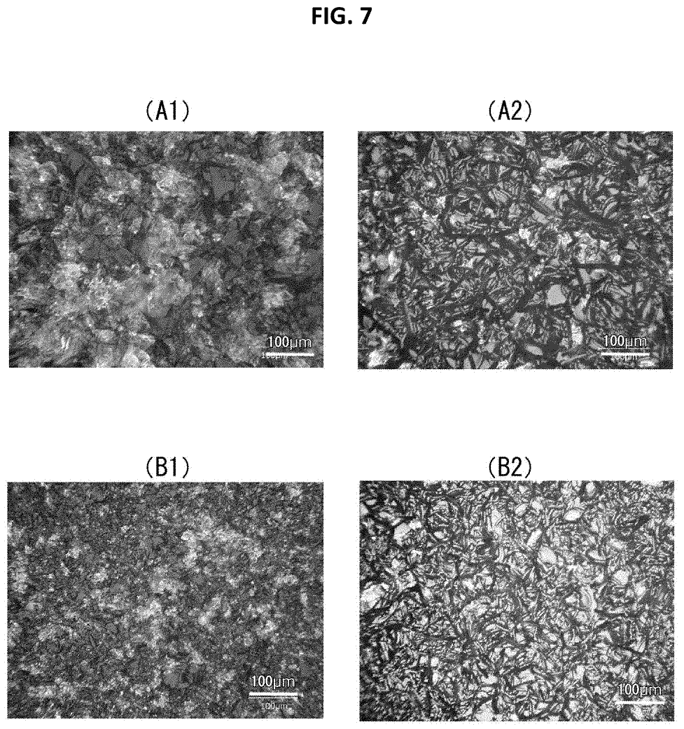

FIG. 7A1 is an enlarged photograph after the blasting treatment with C #80, and FIG. 7A2 is an enlarged photograph after the immersion in the 15 wt. % hydrofluoric acid for 60 minutes after the blasting treatment. Similarly, FIG. 7B1 is an enlarged photograph after the blasting treatment with GC #150, and FIG. 7B2 is an enlarged photograph after the immersion in the 15 wt. % hydrofluoric acid for 60 minutes after the blasting treatment.

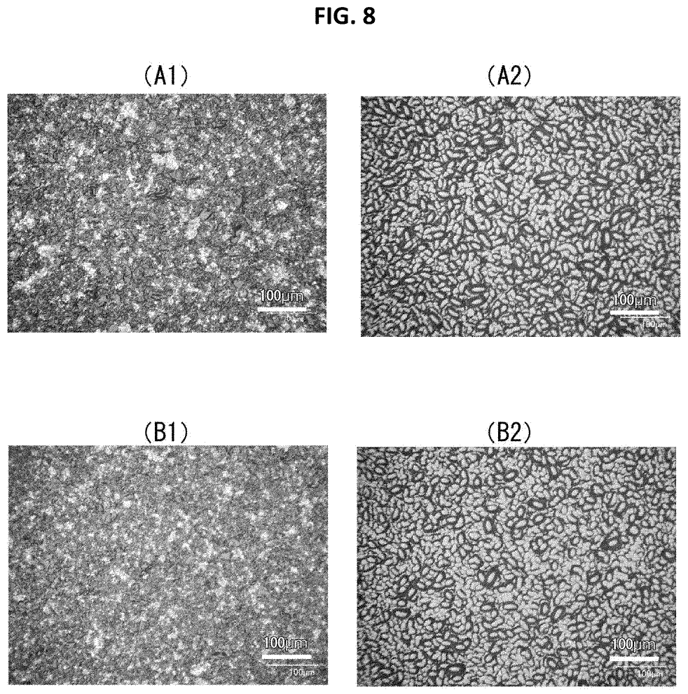

FIG. 8A1 is an enlarged photograph after the blasting treatment with GC #280, and FIG. 8A2 is an enlarged photograph after the immersion in the 15 wt. % hydrofluoric acid for 180 minutes after the blasting treatment. Similarly, FIG. 8B1 is an enlarged photograph after the blasting treatment with C #360, and FIG. 7B2 is an enlarged photograph after the immersion in the 15 wt. % hydrofluoric acid for 180 minutes after the blasting treatment.

As is clear from this experimental result, in the case of the blasting treatment performed with the use of the coarse abrasive grains (C #80, GC #150) shown in FIGS. 7A1 to 7B2, a large number of elongated grooves appear due to the immersion in the hydrofluoric acid. The grooves are cracks developed by the blasting treatment in the planar direction of the base, and opened by etching, and the lengths of the grooves were distributed from several tens μm to several hundreds μm.

In the case of the blasting treatment performed with the use of the fine abrasive grains (GC #280, C #360) shown in FIGS. 8A1 to 8B2, even when the hard etching treatment of immersing for 180 minutes in the 15 wt. % hydrofluoric acid was performed, fine recesses in rice-grain shapes in substantially the same size were distributed over the entire base, without the appearance of elongated opening grooves. Accordingly, damage to the rough surface subjected to the blasting treatment has been found to be increased with the use of the abrasive grit with coarser abrasive grains, thus making elongated grooves in the planar direction more likely to appear by etching with hydrofluoric acid.

### Experimental Example 6

From the above-mentioned result of Experimental Example 4, the adhesion of the sprayed coating was improved on the quartz glass substrate subjected to the heating treatment after the blasting treatment, and the reason therefor was thus examined in this experiment. More specifically, samples subjected to base control by a blasting treatment with the use of abrasive grits of silicon carbide (C #80, GC #150) were subjected to a heating treatment under the condition of fixing at 1170° C. for 60 minutes, and the conditions of the base surfaces before and after the heating treatment were observed under magnification with a microscope.

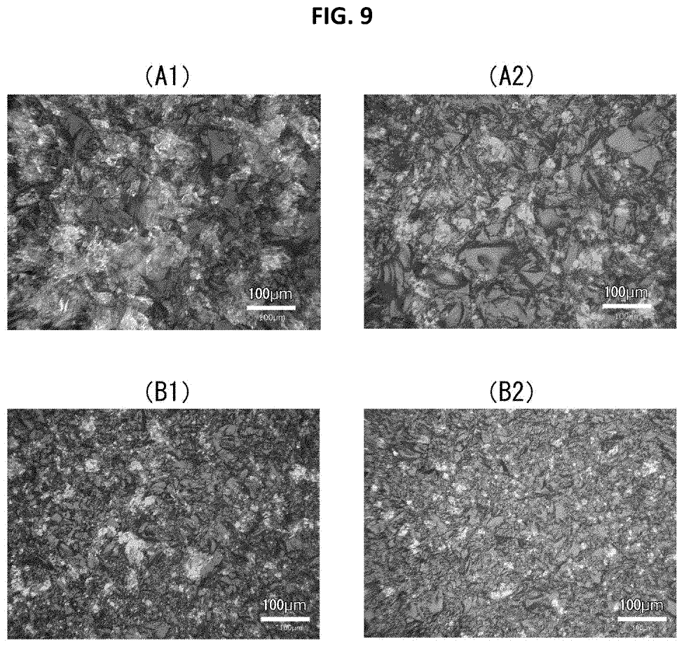

FIG. 9A1 is an enlarged photograph after the blasting treatment with C #80, FIG. 9A2 is an enlarged photograph after the heating treatment following the blasting treatment, and FIG. 9B1 is an enlarged photograph after the blasting treatment with GC #150, and FIG. 9B2 is an enlarged photograph after the annealing treatment following the blasting treatment.

The white parts appearing shiny in white in the enlarged photographs of FIGS. 9A1 to 9B2 are considered as fragile parts in terms of strength, where incident light on the base surface is diffusely reflected due to the presence of surface-layer cracks, and it can be confirmed that the sizes and numbers of white parts (crack parts) are reduced by performing the heating treatment even when any of the abrasive grits is used.

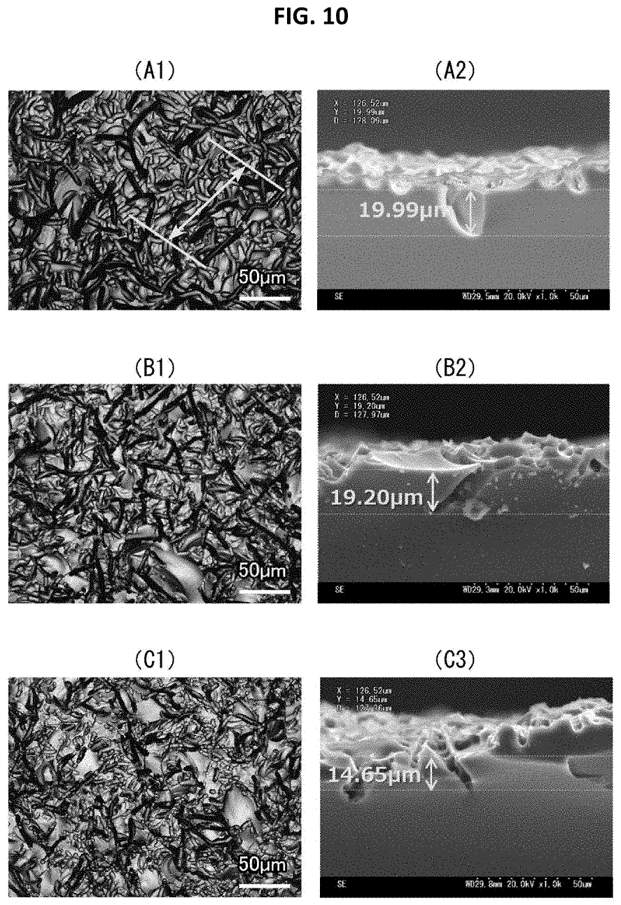

FIGS. 10A1 to 10C3 are intended to verify the effect of the heating treatment, and it has been investigated that microcracks formed by the blasting treatment are appropriately joined by the heating treatment. More specifically, samples subjected to fixing in an electric furnace for 60 minutes at respective heating temperatures of 1000° C., 1100° C., 1170° C., and 1250° C. after the blasting treatment with GC #150 were prepared for optimizing the temperature of the heating treatment performed after the blasting treatment. Next, for the observation of the microcracks joined for each heating temperature under magnification, each sample was immersed in advance in a 15 wt. % hydrofluoric acid (liquid temperature: 23±1° C.) to enlarge the microcracks, thereby facilitating the observation. Further, in this experiment, the material of the substrate was anhydrous synthetic quartz glass.

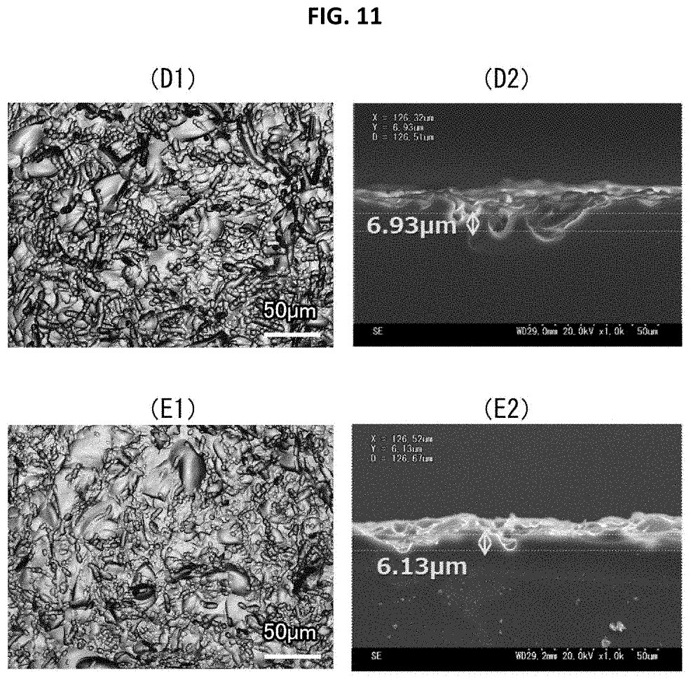

FIG. 10A1 is an enlarged plan photograph of the base surface subjected to the blasting treatment, and FIG. 10A2 is an enlarged cross-section photograph of the base surface etched by the immersion in the hydrofluoric acid for 60 minutes for crack observation. FIG. 10B1 is an enlarged plan photograph of the base surface subjected to the blasting treatment and subjected to the heating treatment of fixing at 1000° C. for 60 minutes, and FIG. 10B2 is an enlarged cross-section photograph of the base surface etched by the immersion in the hydrofluoric acid for 60 minutes for crack observation. FIG. 10C1 is an enlarged plan photograph of the base surface subjected to the blasting treatment and subjected to the heating treatment of fixing at 1100° C. for 60 minutes, and FIG. 10C2 is an enlarged cross-section photograph of the base surface etched by the immersion in the hydrofluoric acid for 60 minutes for crack observation. FIG. 11D1 is an enlarged plan photograph of the base surface subjected to the blasting treatment and subjected to the heating treatment of fixing at 1170° C. for 60 minutes, and FIG. 11D2 is an enlarged cross-section photograph of the base surface etched by the immersion in the hydrofluoric acid for 60 minutes for crack observation. FIG. 11E1 is an enlarged plan photograph of the base surface subjected to the blasting treatment and subjected to the heating treatment of fixing at 1250° C. for 60 minutes, and FIG. 11E2 is an enlarged cross-section photograph of the base surface etched by the immersion in the hydrofluoric acid for 60 minutes for crack observation.

As is clear from the observation results of FIGS. 10A1 to 11E2, large numbers of crack opening grooves in excess of 100 μm in length can be confirmed from the enlarged plan photographs in the case of the heating treatment at the temperatures lower than the strain point (1120° C.) of the anhydrous quartz glass. In the case of the heating treatment at the temperatures higher than the strain point, however, there are almost no such crack opening grooves in excess of 100 μm in length. In addition, it can be seen from the enlarged cross-section photograph that cracks of about 20 μm in depth before the heating treatment are reduced to several μm in depth. In addition, it has been confirmed that cracks are similar in depth to those in the heating treatment at 1170° C., also in the case of the heating treatment at 1250° C. in excess of the annealing point (1220° C.) of the anhydrous quartz glass. More specifically, the minute gaps of the deep cracks generated by the blasting treatment are believed to have been, actually without the viscous flow of the glass material at lower temperatures than the strain point, joined by performing the heating treatment in a temperature range equal to or higher than the strain point. This is believed to improve the mechanical strength of the base surface of the quartz glass substrate subjected to the blasting treatment, and contribute to an improvement in coating adhesion.

It is to be noted that the depths of microcracks at the base surface of the quartz glass substrate (in particular, the depths in the thickness direction of the substrate) can be, as shown in FIGS. 10A1 to 11E2, observed by immersion in the 15 wt. % hydrofluoric acid (liquid temperature: 23±1° C.) for the enlargement of the microcracks.

### Experimental Example 7

In this experiment, with the use of, as a spray material, the silicon (Si) presented in Experimental Example 1, the effect of the coating adhesion improved by the heating treatment for the substrate was verified in the same manner as in Experimental Examples 3 and 4. More specifically, on the substrate subjected to only the blasting treatment and the substrate subjected to the heating treatment after the blasting among the base-control samples prepared in Experimental Example 2, sprayed coatings of silicon (Si) of 5% or less in porosity were formed by atmospheric plasma spraying (APS), and the film thicknesses were adjusted to 300 μm to 400 μm. Then, for each sample, the surface roughness of the base surface of the quartz glass substrate, the surface roughness of the sprayed coating, the film thickness of the sprayed coating, and the tensile adhesion strength were measured, and the condition of the fracture surface after the tensile test was observed. The number of samples was N=3 for each base-control sample, and the measurement of the tensile adhesion strength was performed by the same method as in Experimental Example 1. The results are shown in Table 4 below.

TABLE 4

| | | | Coating | | Roughness | | | | |
|---|---|---|---|---|---|---|---|---|---|
| | | | Roughness | | of Quartz | | | | |
| | | Film | of Sprayed | | Glass Base | | Adhesion | Site of | |
| Base Control | | Thickness | [μm] | | [μm] | | Strength | Fracture | Appearance of |
| Abrasive grit | Post-Treatment | [μm] | Ra | Rmax | Ra | Rmax | [MPa] | Surface | Fracture Surface |
| C#80 | No | 357 | 2.62 | 27.46 | 4.33 | 46.07 | 11.2 | Interface between coating base | [symbol] |
| | Heating Treatment | 350 | 2.91 | 30.47 | 4.66 | 42.91 | 18.6 | Interface between coating base (increased residual Si film) | [symbol] |
| GC#150 | No | 355 | 3.07 | 25.82 | 2.76 | 25.53 | 17.2 | Interface between coating-base (increased residual Si film) | [symbol] |
| | Heating Treatment | 351 | 3.11 | 30.45 | 2.89 | 28.93 | 19.8 | coating fracture | [symbol] |
| GC#280 | No | 352 | 3.04 | 28.80 | 1.88 | 16.67 | 20.3 | coating fracture | [symbol] |
| | Heating Treatment | 345 | 2.84 | 29.93 | 1.86 | 19.66 | 19.8 | coating fracture | [symbol] |
| C#360 | No | 355 | 3.06 | 27.30 | 1.24 | 11.33 | 20.9 | coating fracture | [symbol] |
| | Heating Treatment | 360 | 3.05 | 29.59 | 1.22 | 11.15 | 20.4 | coating fracture | [symbol] |

The samples subjected to the blasting treatment with C #80 and GC #150 has tensile adhesion strength significantly improved by the heating treatment for the substrate. In particular, in the case of the sample subjected to the blasting treatment with GC #150 and then to the heating treatment, the coating itself was bulk-fractured before interfacial peeling of the sprayed coating of silicon (Si) from the base. In addition, in each case of the samples subjected to the blasting treatment with GC #280 and GC #360, the coating itself was bulk-fractured before interfacial peeling of the sprayed coating of silicon (Si) from the base, regardless of whether the heating treatment was performed.

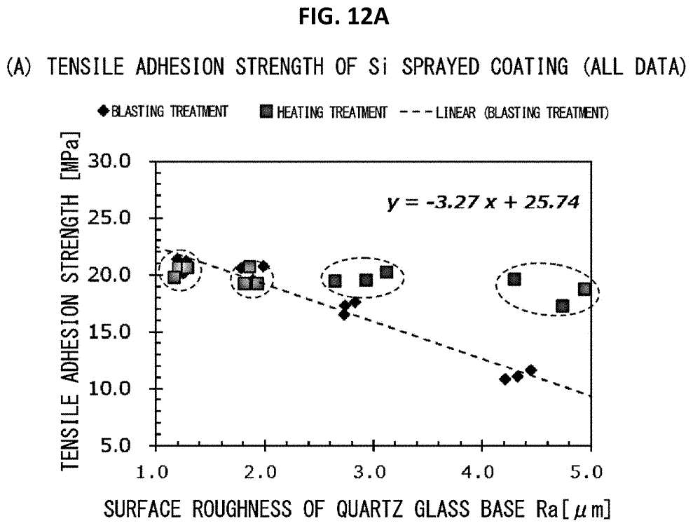

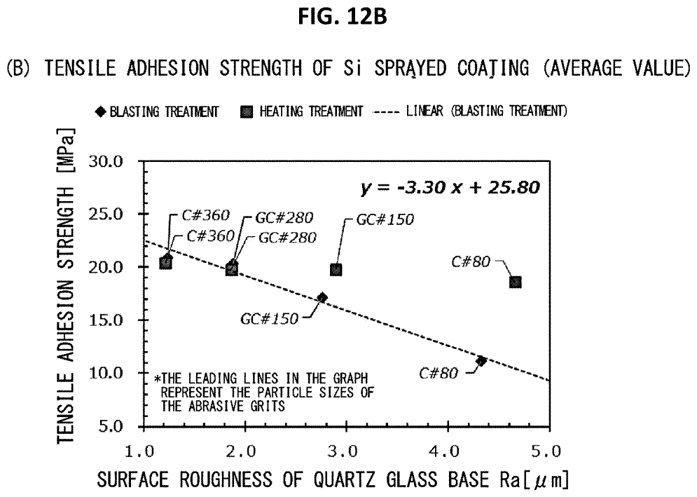

In addition, FIGS. 12A and 12B are graphs obtained by plotting the measurement results of Experimental Example 7, and FIG. 12A and FIG. 12B respectively plot individual data (all data) for each base-control sample and an average value for each base-control sample.

From the results of Table 4 and FIGS. 12A and 12B, it has been confirmed that the sprayed coating of silicon (Si) also has, as with the sprayed coating of yttria (Y₂O₃), a tendency to increase the tensile strength with the decreased surface roughness Ra for the base subjected to only the blasting treatment. Furthermore, it has been confirmed that the base subjected to the blasting treatment and then to the heating treatment has coating adhesion improved as compared to the case of only the blasting treatment, which also has the same tendency as in the case of the yttria (Y₂O₃).

Further, in the case of the sample subjected to the blasting treatment with the GC #150 and then to the heating treatment, and the both samples subjected to the blasting treatment with the GC #280 and the GC #360 with or without the heating treatment, the value of the tensile adhesion strength is approximately 20 MPa, and this is because the sprayed coating of silicon (Si) itself was fractured at around 20 MPa (see the fracture surface photograph after the test in Table 4). The other samples were delaminated at the interface between the coating and the base material, but it has been confirmed that the tensile adhesion strength tends to be increased with the increased residual sprayed film on the quartz glass base surface with the coating peeled off therefrom.

### Experimental Example 8

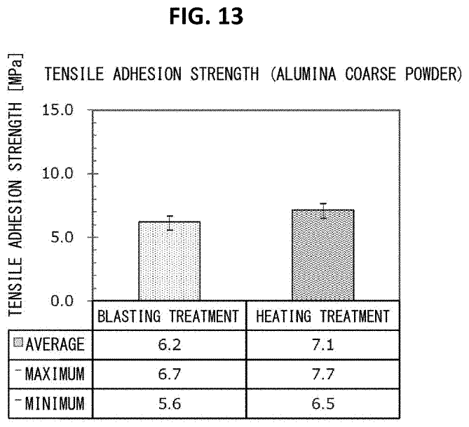

In this experiment, with the use of, as a spray material, the alumina coarse powder presented in Experimental Example 1, the effect of the coating adhesion improved by the heating treatment for the substrate was verified in the same manner as in Experimental Examples 3 and 4. More specifically, on the substrate subjected to only the blasting treatment and the substrate subjected to the heating treatment after the blasting among the base-control samples prepared in Experimental Example 2, sprayed coatings of alumina course powder on the order of 20% in porosity were formed by atmospheric plasma spraying (APS). The number of samples was N=3 for each base-control sample, and for each sample, the film thickness of the sprayed coating, the surface roughness of the sprayed coating, the surface roughness of the base surface of the quartz glass substrate, and the tensile adhesion strength were measured, and the condition of the fracture surface after the tensile test was observed. The average value of the measurement results for each sample is shown in Table 5, and the results of measuring the tensile adhesion strength are shown in FIG. 13. The tensile adhesion strength was measured by the same method as in Experimental Example 1.

TABLE 5

| | | | Roughness | | Roughness | | | | |
|---|---|---|---|---|---|---|---|---|---|
| | | | of Sprayed | | of Quartz | | | | |
| | | Film | Coating | | Glass Base | | Adhesion | Site of | |
| Base Control | | Thickness | [μm] | | [μm] | | Strength | Fracture | Appearance of |
| Abrasive grit | Post-Treatment | [μm] | Ra | Rmax | Ra | Rmax | [MPa] | Surface | Fracture Surface |
| C#80 | No | 350 | 5.06 | 48.29 | 4.48 | 44.45 | 6.2 | Interface between coating-base | [symbol] |
| | Heating Treatment | 351 | 5.06 | 56.53 | 4.56 | 40.14 | 7.1 | Interface between coating-base | [symbol] |

From the results of this experimental example, the coating with the high porosity (that is, the porous coating) has adhesion strength slightly improved by improving the base of the quartz glass substrate, but the adhesion strength was not significantly improved. This is believed to be because the coating with the high porosity originally has a poor anchor effect at the interface between the coating and the base surface. Accordingly, it has been determined that the effect of improving the quartz glass base surface is enhanced when the porosity of the coating is 20% or less, preferably 10% or less, particularly preferably 6% or less.

The quartz glass substrate for the adhesion of a thermal spray coating and the quartz glass part provided with the coating on the substrate according to the present invention can be used for a quartz glass substrate with the enhanced adhesion of a metal or ceramic coating such as a sprayed coating, and a quartz glass part with the glass substrate used, and particularly desirably, can be used as
a chamber constituent member of an apparatus for manufacturing a device such as a semiconductor or a flat panel display.

What is claimed is:

1. A method for manufacturing a quartz glass substrate with a sprayed coating formed, the method comprising:
surface roughening for a base surface of the quartz glass substrate, on which the sprayed coating is formed; and
a heating treatment of heating the substrate after the surface roughening,
wherein the base surface is 0.9 μm or more and 5.0 μm or less in arithmetic mean roughness (Ra) in the surface roughening, and
the heating treatment is performed at a temperature that is equal to or higher than a strain point of the quartz glass, and equal to or lower than a annealing point of the quartz glass.

2. The method for manufacturing a quartz glass substrate according to claim 1, wherein the surface roughening is performed by a blasting treatment, and
microcracks generated by the blasting treatment are reduced by the heating treatment.

3. A method for manufacturing a quartz glass part with a sprayed coating of a metal or a ceramic formed on a quartz glass substrate,
wherein the quartz glass substrate is manufactured by the manufacturing method according to claim 1, and
the method comprises a coating forming treatment of forming a sprayed coating of a metal or a ceramic on the base surface subjected to the surface roughening, after the heating treatment.

4. The method for manufacturing a quartz glass part according to claim 3, wherein the sprayed coating is 20% or less in porosity.

5. A quartz glass part with a sprayed coating of a metal or a ceramic formed on a quartz glass substrate,
a base surface of the quartz glass substrate with the sprayed coating formed is 0.9 μm or more and 5.0 μm or less in arithmetic mean roughness (Ra),
a microcrack at the base surface is 18 μm or less in depth, and
the sprayed coating is 300 μm or more in film thickness, and 20% or less in porosity.
